(19) United States
(12) Patent Application Publication
(10) Pub. No.: US 2024/0399485 A1
(43) Pub. Date: Dec. 5, 2024

(54) WELDING-TYPE POWER SUPPLIES AND SYSTEMS HAVING MULTIPLE SOURCES OF INPUT POWER

(71) Applicant: Illinois Tool Works Inc., Glenview, IL (US)

(72) Inventor: Craig Steven Knoener, Appleton, WI (US)

(21) Appl. No.: 18/663,598

(22) Filed: May 14, 2024

Related U.S. Application Data
(60) Provisional application No. 63/505,145, filed on May 31, 2023.

(51) Int. Cl. B23K 9/10

(52) U.S. Cl. CPC B23K 9/1075

(57) ABSTRACT

Disclosed example welding-type power supplies include: two or more power converters configured to receive at least two different sources of input power, and to convert the at least two different sources of input power to welding-type power; and control circuitry configured to: determine a type of source of each of the sources of input power; and control the two or more power converters based on the type of source.

### RELATED APPLICATIONS

The present application claims the benefit of U.S. Provisional Patent Application Ser. No. 63/505,145, filed May 31, 2023, entitled “WELDING-TYPE POWER SUPPLIES AND SYSTEMS HAVING MULTIPLE SOURCES OF INPUT POWER.” The entirety of U.S. Provisional Patent Application Ser. No. 63/505,145 is expressly incorporated herein by reference.

### FIELD OF THE DISCLOSURE

This disclosure relates generally to welding systems, and more particularly to welding-type power supplies and systems having multiple sources of input power.

### BACKGROUND

Conventional welding power supplies are limited to their rated output, which is typically based on the source of input power provided to the power supply. In some cases, battery-assisted systems have been used to increase the typical capacity of welding power supplies. However, conventional battery-assisted systems are either integrated with the welding power supply or require the welding power supply to be reconfigured between charging the battery and welding.

### SUMMARY

Welding-type power supplies and systems having multiple sources of input power are disclosed, substantially as illustrated by and described in connection with at least one of the figures, as set forth more completely in the claims.

### BRIEF DESCRIPTION OF THE DRAWINGS

FIG. 1 is a block diagram of an example multi-input welding-type system in accordance with aspects of this disclosure.

FIG. 2 illustrates an example user interface which may implement the user interface of FIG. 1 to display power drawn by the welding-type power supply from each of multiple input sources.

FIG. 3 is a flowchart representative of example machine-readable instructions which may be executed by the welding-type power supply of FIG. 1 to manage and use multiple input power sources for welding-type operations.

FIGS. 4A, 4B, and 4C illustrate a flowchart representative of example machine-readable instructions which may be executed by the welding-type power supply of FIG. 1 to initialize the power supply.

FIGS. 5A and 5B illustrate a flowchart representative of example machine-readable instructions which may be executed by the welding-type power supply of FIG. 1 to determine types of input power sources connected to the welding-type power supply.

The figures are not necessarily to scale. Wherever appropriate, similar or identical reference numerals are used to refer to similar or identical components.

### DETAILED DESCRIPTION

Some conventional welding-type power supplies are configured to be used with different AC input voltages, such as 120 VAC and 230 VAC. Such conventional power supplies are able to restrict or enable output power at higher levels based on the input voltage, which may reduce the types of welding tasks which can be performed, or makes such welding tasks slower due to the reduced available output. In many real-world welding scenarios, a 230 VAC receptacle is preferred for the welding task but is unavailable at the location of the task.

Disclosed example welding-type power supplies allow connection and utilization of multiple sources of AC and/or DC input power, such as multiple mains (utility) power sources, batteries, engine-driven generators, battery-powered 120 VAC inverter power sources, and/or any other sources of input power. For example, disclosed welding-type power supplies may be connected to multiple 120 VAC mains power sources, to a 120 VAC mains power source and an engine-driven generator or battery-powered 120 VAC power source, to multiple engine-driven generators and/or battery-powered 120 VAC power sources, and/or any other sources of input power to allow for output of higher power levels than would be achievable via a single 120 VAC mains power source operating on commonly found circuit breakers (e.g., 15 Ampere or 20 Ampere circuit breakers). Additionally or alternatively, any 120 VAC configuration may further include or use batteries to supplement the input power.

Disclosed example power supplies include separate power converters for the different input power connections, each of which converts the input power to supply an intermediate bus. Disclosed example power supplies further include power conversion circuitry which converts power from the intermediate bus to the desired welding-type output power. Both the input power converters and the power conversion circuitry may be controlled based on the types of input power sources connected to the welding-type power supply. In some examples, one input power source may be drawn as a leading power source and one or more additional power sources are drawn as secondary power sources.

Disclosed example welding-type power supplies provide an operator with higher-power welding-type operation performance in the absence of higher-voltage input power sources, as well as providing enhanced flexibility for accepting and using different types of input power sources. Disclosed example welding-type power supplies can operate using input sources having different frequencies and/or different voltages (e.g., a 120 VAC source and a DC battery source, a 120 VAC source and a 230 VAC source, etc.).

As used herein, a “leading input power source” refers to an input power source which is drawn up to a predetermined capacity prior to drawing power from another input power source. As used herein, a “following input power source” refers to an input power source which is drawn under one or more predetermined conditions, such as an input power draw exceeding the capacity of a leading power source and/or another following power source.

As used herein, the term “welding-type power” refers to power suitable for welding, plasma cutting, induction heating, CAC-A and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, a “bidirectional DC-DC converter” refers to any bidirectional circuit topology that converts voltage up and/or down in a first direction and converts voltage up and/or down in a second direction. Example bidirectional DC-DC converters include buck-boost and/or boost-buck topologies, a SEPIC converter, a Ćuk converter, or the like. For example, a bidirectional DC-DC converter may refer to a DC-DC converter that boosts voltage in one direction and bucks voltage in the opposing direction.

As used herein, the term “recognized battery unit” refers to a battery unit that is approved, authorized, and/or otherwise has identifiable minimum characteristics, such as charge state, nominal voltage, minimum voltage, maximum voltage, and/or charge capacity. Recognition can occur through signaling, measurement, and/or any other mechanism.

As used herein, a “circuit” includes any analog and/or digital components, power and/or control elements, such as a microprocessor, digital signal processor (DSP), software, and the like, discrete and/or integrated components, or portions and/or combinations thereof.

Disclosed example welding-type power supplies include: two or more power converters configured to receive at least two different sources of input power, and to convert the at least two different sources of input power to welding-type power; and control circuitry configured to: determine a type of source of each of the sources of input power; and control the two or more power converters based on the type of source.

In some example welding-type power supplies, the two or more power converters are configured to convert power from each of the at least two sources to intermediate power having a same intermediate voltage, and convert the intermediate power to a welding-type power. In some example welding-type power supplies, the type of source of each of the sources of input power is selected from: a 120 VAC mains source; a branch of a multiple-branch 120 VAC mains source; a 120 VAC line of a split 240 VAC mains source; a battery-powered 120 VAC source; an engine-driven 120 VAC generator source; or a DC energy storage device.

In some example welding-type power supplies, the control circuitry is configured to, in response to determining that a first one of the sources is a 120 VAC mains source and a second one of the sources is a battery-powered 120 VAC source or an engine-driven 120 VAC generator source, control the two or more power converters to use the first one of the sources as a leading input power source and use the second one of the sources as a follower input power source.

In some example welding-type power supplies, the control circuitry is configured to, in response to determining that a first one of the sources is a first 120 VAC line of a split 240 VAC mains source and a second one of the sources is a second 120 VAC line of the 240 VAC mains source, control the two or more power converters to divide the input power between the first and second ones of the sources.

In some example welding-type power supplies, the control circuitry is configured to, in response to determining that a first one of the sources is a first branch of a 120 VAC mains source and a second one of the sources is a second branch of the 120 VAC mains source, control the two or more power converters to divide the input power between the first and second ones of the sources.

In some example welding-type power supplies, the control circuitry is configured to, in response to determining that a first one of the sources is a first branch of a 120 VAC mains source and a second one of the sources is the same first branch of the 120 VAC mains source, disable at least the second one of the two or more power converters to prevent drawing power from the same branch via multiple power converters.

In some example welding-type power supplies, the control circuitry is configured to, in response to determining that a first one of the sources is a first battery-powered 120 VAC source or engine-driven 120 VAC generator source and a second one of the sources is a second battery-powered 120 VAC source or engine-driven 120 VAC generator source, control the two or more power converters to divide the input power between the first and second ones of the sources.

In some example welding-type power supplies, the control circuitry is configured to, in response to determining that a first one of the sources is a first energy storage device and a second one of the sources is a second energy storage device, control the two or more power converters to divide the input power between the first and second ones of the sources.

In some example welding-type power supplies, the control circuitry is configured to, in response to determining that a first one of the sources is a 120 VAC mains source and a second one of the sources is an energy storage device, control the two or more power converters to use the first one of the sources as a leading input power source and use the second one of the sources as a following input power source.

In some example welding-type power supplies, the control circuitry is configured to, in response to determining that a first one of the sources is a battery-powered 120 VAC source or an engine-driven 120 VAC generator source and a second one of the sources is an energy storage device, control the two or more power converters to use the first one of the sources as a leading input power source and use the second one of the sources as a following input power source.

In some example welding-type power supplies, the control circuitry is configured to determine the type of source of the first input power based on at least one of: a characteristic of a voltage waveform or a current waveform of the first input power; a change in frequency in response to a change in load on the first input power; a magnitude of variation in voltage of the first input power in response to a change in load on the first input power; or a measured source impedance of the source of the first input power. In some example welding-type power supplies, the control circuitry is configured to: determine an impedance for each of the sources of input power; and control the two or more power converters to draw power from the one of the sources that has a lower impedance to output dynamic portions of the welding-type power.

In some example welding-type power supplies, the two or more power converters comprise respective power factor correction circuits. In some such example welding-type power supplies, the control circuitry is configured to, in response to a step change in a load on the welding-type output power, control the two or more power converters to change the load drawn from one of the sources of input power based on the corresponding power factor of each of the power factor correction circuits.

In some example welding-type power supplies, the sources of input power have different input voltages. In some example welding-type power supplies, the sources of input power have different input frequencies. In some example welding-type power supplies, the sources of input power have different input phases.

Some example welding-type power supplies further include a user interface configured to display amounts of power drawn from each of the two or more input power sources. In some example welding-type power supplies, the user interface is configured to display at least one of a percentage of total consumed power is drawn per source or a measured power drawn per source for a welding-type operation.

Some disclosed example welding-type power supplies include: two or more power converters configured to receive at least two different sources of input power via corresponding input connectors, and to convert the at least two different sources of input power to welding-type power; and control circuitry configured to: control the two or more power converters to convert the sources of input power to welding-type power; and in response to determining that one of the sources of input power is disconnected, controlling a switch to disconnect the disconnected one of the input connectors from other ones of the sources of input power.

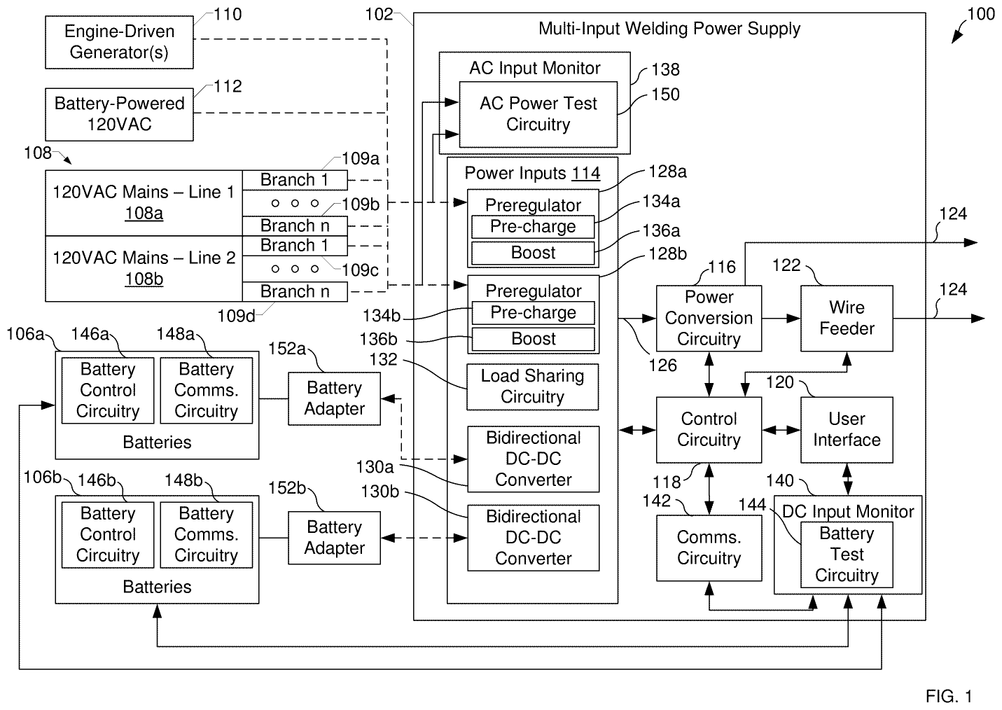

FIG. 1 is a block diagram of an example multi-input welding-type system 100. The example multi-input welding-type system 100 of FIG. 1 includes a multi-input welding-type power supply 102.

The multi-input welding-type power supply 102 may be connected to multiple sources of input power including, but not limited to DC energy storage device(s) 106a, 106b, a mains source 108 (e.g., a 120 VAC mains source), an engine-driven generator source 110 (e.g., a 120 VAC source), a battery-powered 120 VAC source 112 (e.g., a 120 VAC source), and/or any other appropriate input power source. The battery-powered 120 VAC source 112 may be, for example, an inverter circuit which converts battery power to a 120 VAC output.

The example mains source 108 may include multiple lines 108a, 108b, and/or each of the lines 108a, 108b may include multiple branches 109a, 109b, 109c, 109d. As used herein, a “branch” of a mains source (also referred to as a utility power source) refers to a portion of the mains source which is controlled by a single circuit breaker, in which a mains source may have multiple branches per line. While the example mains source 108 of FIG. 1 is a 120 VAC source (e.g., 240 VAC when two 120 VAC lines are used), the example multi-input welding-type power supply 102 may be configured to use different mains voltages (e.g., 120 VAC and 230 VAC).

The energy storage device(s) 106 may include any type or combination of types of energy storage devices, such as batteries, supercapacitors, thermal energy storage, chemical energy storage, and/or mechanical energy storage devices. While the following examples are discussed with reference to batteries, this disclosure applies to any other type of energy storage that is capable of adaptation for welding.

As disclosed in more detail herein, the multi-input welding-type power supply 102 may draw power from multiple ones of the sources 106-112 to perform welding-type operations with performance that would typically be unattainable using individual ones of the same set of input sources.

The multi-input welding-type power supply 102 includes a set of power inputs 114, power conversion circuitry 116, control circuitry 118, a user interface 120, and a wire feeder 122.

The power conversion circuitry 116 converts direct current (DC) power to a welding-type output 124. The DC power used by the power conversion circuitry 116 is received from the power inputs 114 via an intermediate DC bus 126. The power inputs 114 may include appropriate connectors and circuitry to allow connection of desired ones of the input sources 106 to the multi-input welding-type power supply 102 and to convert the input power to supply the intermediate bus 126 at a desired voltage.

The example power inputs 114 of FIG. 1 include preregulator power converters 128a, 128b (referred to herein as preregulators), bidirectional DC-DC power converters 130a, 130b (referred to herein as DC-DC converters), and load sharing circuitry 132. The preregulators 128a, 128b are connected to receive AC input sources, such as the mains sources 108, generator source 110, and/or battery-powered VAC sources 112, and output DC current to supply the intermediate bus 126. To this end, the example preregulators 128a, 128b include circuitry to perform rectification of the AC input power, power factor correction, and/or preregulation (e.g., boosting and/or bucking the voltage to the voltage of the intermediate bus 126). The preregulators 128a, 128b include pre-charge circuitry 134a, 134b and boost circuitry 136a, 136b. The example pre-charge circuitry 134a, 134b supplies energy to at least partially charge bus capacitors of the intermediate bus 126, and the boost circuitry 136a, 136b supplies additional energy to support the full intermediate voltage of the intermediate bus 126. The example preregulators 128a, 128b may further include a switch or other circuitry to electrically and/or physically disconnect an input connector from the intermediate bus 126 and/or from other connected sources of input power when the corresponding preregulator 128a, 128b is not connected to an input power source.

In some examples, the power inputs 114 may include only a single pre-charge circuitry 134a to pre-charge the intermediate bus 126 using a connected one of the input power sources 106-112.

The load sharing circuitry 132 controls a balance of power input from the input power sources 106-112. For example, the control circuitry 118 may control the load sharing circuitry 132 to cause relatively more power to be drawn from the mains power source 108 to preserve battery life and/or avoid unnecessary battery discharge. The control circuitry 118 may also control the load sharing circuitry 132 to cause relatively more power to be drawn from the batteries, such as to reduce high electricity costs and/or save fuel when the connected AC input power source is powered by an engine-driven (or other portable fuel-driven) source. Additionally, the load sharing circuitry 132 may be controlled to use different types of power sources as leading power sources and/or following power sources. The status of a particular input power source as a leading power source or a following power source may be controlled based on the particular combinations of types of power sources being used.

In some examples, the DC-DC converters 130a, 130b include multiple converters and/or multi-stage converters, to supply a DC bus with energy from multiple batteries or other energy storage devices. In some examples, the DC-DC converters 130a, 130b may accept energy from different types of batteries simultaneously, in addition to accepting energy from multiple batteries of the same type. The bidirectional DC-DC converters 130a, 130b may include circuitry that converts input power (e.g., from the DC bus 126 powered by the AC input power sources 108-112) to charge the batteries 106. The bidirectional DC-DC converter 130a, 130b also converts the stored power in the batteries 106 to converted power to output to the power conversion circuitry 116 (e.g., via one or more DC buses). When the multi-input welding-type power supply 102 is connected to both the AC input power sources 108 and to the batteries 106, the multi-input welding-type power supply 102 may charge the batteries 106. Conversely, when energy is required that is not available from the AC input power sources 108-112, the batteries 106 may provide power to the multi-input welding-type power supply 102.

The power conversion circuitry 116 converts the energy present at the DC bus 126 (e.g., from the power inputs 114) to the welding-type output 124. For example, the power conversion circuitry 116 may include a switched mode power supply, which is controlled by the control circuitry 118 based on specified weld parameters and feedback.

The control circuitry 118 controls the power conversion circuitry 116 to output the welding-type output 124. The control circuitry 118 controls the preregulators 128a, 128b, the bidirectional DC-DC converters 130a, 130b, and the load sharing circuitry 132 to convert power from the input power sources 106-112 to supply the DC bus 126 and/or the power conversion circuitry 116. The control circuitry 118 further controls the bidirectional DC-DC converter 130a, 130b to charge the batteries 106 when the AC input power source 108-112 is available and at least a portion of the AC input power source 108-112 is available for charging the batteries 106 (e.g., the AC input power source 108-112 is not completely consumed by the power conversion circuitry 116 and/or the wire feeder 122).

The example wire feeder 122 includes a wire feed motor to provide electrode wire to the welding operation (e.g., when the welding operation involves a wire feeder, such as when gas metal arc welding, flux cored arc welding, etc.). When the welding operation involves a wire feeder, the control circuitry 118 controls the wire feeder 122. The wire feeder 122 may be powered by the welding-type output 124 or by another output from the power conversion circuitry 116. In some other examples, the wire feeder 122 may be a separate device connected to the welding-type output 124 external to the multi-input welding-type power supply 102.

The user interface 120 enables input to the multi-input welding-type power supply 102 and/or output from the multi-input welding-type power supply 102 to a user. The control circuitry 118 may indicate the state of charge of the batteries 106 and/or a mode of operation, such as a battery charging mode, an external power welding mode (e.g., welding mode powered by an AC input power source), a combination welding-charging mode (e.g., welding and charging the batteries 106 using AC input power sources 108-112), a battery powered welding mode, or a welding-type mode (e.g., welding boost mode powered by multiple sources of AC power and/or battery power), of the multi-input welding-type power supply 102 via the user interface 120. Additionally or alternatively, the user interface 120 may display amounts of power used from each of multiple input sources during a welding-type operation (e.g., Ampere-hours used per input source, percentages of total energy used, etc.).

The user interface 120 further includes inputs to allow an operator to specify welding parameters, such as a workpiece thickness, output voltage, output current, wire feed speed, welding wire diameter, welding wire type, welding process, pulse frequency, or pulse magnitude.

The user interface 120 may allow the operator to identify the types of input sources connected to the power inputs 114. Additionally or alternatively, the control circuitry 118 may automatically determine the types of connected input sources using detection circuitry, such as an AC input monitor 138, a DC input monitor 140, and/or communications circuitry 142.

The example control circuitry 118 monitors the properties of connected batteries 106 and/or AC input power sources 108-112 to provide information about the batteries, AC input power, and welding capacity to the operator. For example, as the power available to the power input 114 from the batteries 106 increases and/or multiple sources of AC input power are connected, the control circuitry 118 may determine that higher-power welding-type operations are available, the types of usable weld processes increases, the usable consumable sizes (e.g., electrode diameters) increase, and/or other enhancements and/or augmentations to welding may become available. Conversely, as the power available from the batteries 106 decreases and/or AC input power sources 108-112 are disconnected, the control circuitry 118 may determine that the thickness of materials that can be welded decreases, less time is available to weld for a given set of parameters, more input power sources 106-112 may be needed, the types of usable weld processes are limited, the usable consumable sizes (e.g., electrode diameters) decrease, and/or the multi-input welding-type power supply 102 becomes otherwise limited.

The control circuitry 118 receives and uses properties of the batteries 106 and/or AC input power sources 108-112 to determine welding capacity, supported values for welding parameters, and/or alternatives to unsupported values for welding parameters. To determine the properties of the batteries 106, the example multi-input welding-type power supply 102 includes the DC input monitor 140 and/or the communications circuitry 142.

The DC input monitor 140 may interface with the batteries 106 to determine one or more properties of the batteries 106. For example, the DC input monitor 140 may include battery test circuitry 144 which can function as one or more loads to the batteries 106 while measuring changes in voltage, current, temperature, and/or other properties. Additionally or alternatively, the DC input monitor 140 may supply a small current to one of the batteries 106 (e.g., from an AC input power source 108-112 or another one of the batteries 106) to determine the response. In still other examples, the battery test circuitry 144 may perform voltage and/or current measurements, and/or measure voltage and/or current over time, to learn or infer the properties of the batteries 106. By analyzing the response of the batteries 106, the DC input monitor 140 can determine properties of the batteries 106 for use by the control circuitry 118 in determining welding capacity.

Some types of batteries 106 include battery control circuitry 146a, 146b and/or battery communications circuitry 148a, 148b. For example, battery control circuitry 146a, 146b may control internal load balancing of the batteries 106a, 106b, and/or battery communications circuitry 148a, 148b may allow for communication of battery information to external devices and/or implement control of one or more aspects of the batteries 106 by an external device. The example battery communications circuitry 148a, 148b of the batteries 106 and/or the communications circuitry 142 of the multi-input welding-type power supply 102 may be configured to communicate through any wired or wireless techniques. For example, the battery communications circuitry 148a, 148b and/or the communications circuitry 142 may communicate via serial communications through the battery contacts. In other examples, the battery communications circuitry 148a, 148b and/or the communications circuitry 142 may communicate wirelessly via radio frequency identification (RFID), near field communications (NFC), Bluetooth®, and/or any other close-proximity communications, or any other desired wireless communications technique.

The AC input monitor 138 monitors the presence and properties of the AC input power sources 108-112, and provides the properties of the AC input power sources 108-112 to the control circuitry 118 to determine welding capacity and/or load sharing. Example properties of the AC input power source 108-112 that may be monitored include type of input source, AC voltage, number of phases, frequency, average current limit, peak current limit, a circuit breaker, and/or a circuit breaker rating of the mains power. Additional properties may include relative properties of mains power, such as whether multiple mains input power sources 108 are on different lines of a multiple-line installation, whether multiple mains input power sources 108 are on different branches of a same line, and/or whether multiple AC input sources are different source types. The AC input monitor 138 may receive one or more properties via the user interface 120 and/or by testing the AC input power sources 108-112 via AC power test circuitry 150. The AC power test circuitry 150 may, for example, measure the AC voltage and/or frequency via a voltage monitor, apply a predetermined load to one or more sources of AC input power 108-112 to measure a voltage and/or current response, measure impedances of one or more sources of AC input power, and/or any other measurable properties of the AC input power sources 108-112. In some examples, the user interface 120 may allow the operator to input properties of the AC input power sources 108-112, such as a circuit breaker value (e.g., 15A circuit breaker, 20A circuit breaker, etc.). In some such examples, the control circuitry 118 determines one or more other properties based on one or more input properties (e.g., peak current limit and average current of the 120 VAC mains power 108 based on the circuit breaker property). The properties of the AC input power sources 108-112 may be provided to the control circuitry 118 for determination of welding capacity (e.g., in combination with the properties of the batteries 106).

In some examples, the user interface 120 may provide a power selection input that defines different levels of power to be drawn from the AC input power sources 108-112 and/or from the batteries 106.

When multiple sources of input power are connected to the multi-input welding-type power supply 102, the control circuitry 118 determines the type of sources of each of the connected sources, and controls the power inputs 114 and the power conversion circuitry 116 based on the determined types. When using multiple sources 108-112 of input power, the control circuitry 118 permits the power conversion circuitry 116 to operate at higher levels of output power than when a single one of the same sources 108-112 is used. For example, for a multi-input welding-type power supply 102 that is capable of operation at 230 VAC inputs, the multi-input welding-type power supply 102 may be controlled to output the same or similar levels of output power using two 120 VAC sources 108-112 of input power and/or 120 VAC source 108-112 with one or more battery sources 106.

When one connected input power source is the 120 VAC mains power 108a, and the other source is an engine-driven generator 110, a battery-powered 120 VAC source 112, and/or batteries 106a, 106b, the control circuitry 118 may control the preregulator 128a and the preregulator 128b or bidirectional DC-DC converters 130a, 130b to limit power draw from the engine-driven generator 110, the battery-powered 120 VAC source 112, or the batteries 106a, 106b, and to use the 120 VAC mains power source 108a as the leading power source. For battery-powered sources 106a, 106b, 112, using the 120 VAC mains power source 108a as the leading power source reduces the number of charge/discharge cycles of the batteries 106a, 106b, and may reduce the electrical operating costs. For engine-driven sources 110, using the 120 VAC mains power source 108a as the leading power source reduces the load and fuel consumption, improves the generator operating life, and/or reduces engine noise.

In response to determining that a first one of the sources is a 120 VAC mains source 108 and a second one of the sources is a battery-powered 120 VAC source 112 or an engine-driven 120 VAC generator source 110, the control circuitry 118 controls (e.g., via the load sharing circuitry 132) the preregulators 128a, 128b to use the 120 VAC mains source 108 as a leading input power source, and use the battery-powered 120 VAC source 112 or the engine-driven 120 VAC generator source 110 as a follower input power source.

In response to determining that a first one of the sources is a first 120 VAC line of a split 240 VAC mains source and a second one of the sources is a second 120 VAC line of the 240 VAC mains source, the control circuitry 118 controls (e.g., via the load sharing circuitry 132) the preregulators 128a, 128b to divide the input power between the first and second 120 VAC lines 108a, 108b. Similarly, in response to determining that a first one of the sources is a first branch 109a of the 120 VAC mains source 108 and a second one of the sources is a second branch 109b of the 120 VAC mains source 108, the control circuitry 118 controls (e.g., via the load sharing circuitry 132) the preregulators 128a, 128b to divide the input power between the first and second ones of the sources. The preregulators 128a, 128b may divide the input power evenly or unevenly.

In response to determining that a first one of the sources is a first branch 109a-109d of the 120 VAC mains source 108 and a second one of the sources is the same first branch 109a-109d of the 120 VAC mains source 108, the control circuitry 118 controls (e.g., via the load sharing circuitry 132) the preregulators 128a, 128b to disable at least the second one of the two or more preregulators 128a, 128b to prevent drawing power from the same branch 109a-109d via multiple preregulators 128a, 128b. In some examples, the control circuitry 118 disables both preregulators 128a, 128b and alerts the operator (e.g., via the user interface 120) that the same input power source is impermissibly connected to the multi-input welding-type power supply 102 via multiple connections.

In response to determining that a first one of the sources is a first battery-powered 120 VAC source 112 or engine-driven 120 VAC generator source 110 and a second one of the sources is a second battery-powered 120 VAC source 112 or engine-driven 120 VAC generator source 110, the control circuitry 118 controls (e.g., via the load sharing circuitry 132) the preregulators 128a, 128b to divide the input power between the first and second ones of the sources. The preregulators 128a, 128b may divide the input power evenly or unevenly.

In response to determining that a first one of the sources is a first battery 106a and a second one of the sources is a second battery 106b, the control circuitry 118 controls (e.g., via the load sharing circuitry 132) the DC-DC converters 130a, 130b to divide the input power between the first and second ones of the sources. The DC-DC converters 130a, 130b may divide the input power evenly or unevenly, which may be based on determined properties of the batteries 106a, 106b.

In response to determining that a first one of the sources is a 120 VAC mains source 108 and a second one of the sources is a battery 106, the control circuitry 118 controls (e.g., via the load sharing circuitry 132) the preregulators 128a and the DC-DC converter 130a to use the 120 VAC mains source 108 as a leading input power source and use the battery 106a as a following input power source. Similarly, in response to determining that a first one of the sources is a battery-powered 120 VAC source 112 or an engine-driven 120 VAC generator source 110 and a second one of the sources is battery 106a, the control circuitry 118 may control (e.g., via the load sharing circuitry 132) the preregulators 128a and the DC-DC converter 130a to use the battery-powered 120 VAC source 112 or the engine-driven 120 VAC generator source 110 as the leading input power source and use the battery 106a as a following input power source. However, in other examples, the operator may be permitted to select a power balancing mode that causes the control circuitry 118 to control the preregulators 128a and the DC-DC converter 130a to use the battery 106a as the leading power source and an engine-driven 120 VAC generator source 110 as a secondary source (e.g., to conserve fuel).

In some examples, the user could input the power source types to the control circuitry 118 via the user interface 120. In other examples, the control circuitry 118 automatically identifies the types of power sources connected to the multi-input welding-type power supply 102.

To identify connected batteries 106a, 106b, the example control circuitry 118 receives voltage information collected by the DC input monitor 140 and/or battery properties identified by the communications circuitry 142.

To determine whether a connected one of the AC power sources 108-112 is an engine-driven generator 110 or a battery-powered 120 VAC source 112, the example control circuitry 118 may receive measurement information from the AC input monitor 138. For example, the AC power test circuitry 150 may measure voltage, current, frequency, and/or impedance of the connected source to observe behavior characteristic of an engine-driven generator 110, a battery-powered 120 VAC source 112, and/or any other non-mains power source. In some examples, the control circuitry 118 observes the presence of a modified sine wave to determine that the connected input power source 108-112 is an engine-driven generator 110 or a battery-powered 120 VAC source 112. In some other examples, the control circuitry 118 controls the preregulator 128a, 128b (e.g., the pre-charging circuitry 134a, 134b, the boost circuitry 136a, 136b) to vary a power draw (e.g., apply a rapid increase and/or decrease in power draw), and the AC power test circuitry 150 monitors the frequency to measure variations in frequency in response to the varying load and/or monitors the input voltage to measure voltage regulation in response to the varying load. More than a threshold variation in frequency and/or line voltage regulation may indicate that the connected power source 108-112 is an engine-driven generator 110 or a battery-powered 120 VAC source 112. In still other examples, the AC power test circuitry 150 measures the source impedance of the input power source 108-112. For example, a source impedance higher than a threshold may indicate that the connected power source 108-112 is an engine-driven generator 110 or a battery-powered 120 VAC source 112, while a source impedance lower than the threshold may indicate that the connected power source 108-112 is a mains power source 108a, 108b. Using one or more of these techniques, and/or any other techniques, the control circuitry 118 determines a type of connected power source.

If the multi-input welding-type power supply 102 is connected to two or more mains power sources 108a (e.g., via two or more plugs connected to two or more outlets), the control circuitry 118 determines whether the connected power sources 108 are on the same line (e.g., line 108a, line 108b) and/or on the same branch (e.g., line 1, branch 1 109a; line 1, branch n 109b, etc.). The control circuitry 118 may determine whether the connected power sources 108 are different lines by measuring a voltage difference between the connected power sources 108 (e.g., via a voltage sensor of the AC power test circuitry 150). If the power sources 108 are on different lines 108a, 108b, then the measured voltages have opposite polarities and/or the difference between the lines 108a, 108b is approximately double the individual line voltage (e.g., 240 VAC for the example 120 VAC mains power sources 108a, 108b).

If the power sources 108 are determined to be on the same line (e.g., line 108a), the control circuitry 118 determines whether the welders are on the same branch or different branches. For example, the control circuitry 118 may control the AC power test circuitry 150 or the preregulators 128a, 128b to draw current differently from the sources, such as by allowing the voltage of the DC bus 126 to fall, and then quickly charging the DC bus 126 back up with only one of the connected sources 106-112, thereby creating a difference in current draw. During the different current draw, the AC power test circuitry 150 measures the input voltage of both sources. If the voltage difference between the two connected sources 108 is less than a threshold (e.g., close to zero), then the control circuitry 118 determines that the connected sources 108 are on the same branch 109a-109d. In some examples, the control circuitry 118 may disallow operation of welding or control the power inputs 114 to disconnect one of the connected mains power sources 108 from the corresponding preregulator 128a, 128b. The control circuitry 118 may further output a notification or alert via the user interface 120 and/or the communications circuitry 142.

In some examples, the control circuitry 118 may use other information to confirm the determined types of connected power sources 106-112. For example, 120 VAC mains line sources 108a, 108b and/or branches 109a-109d are grounded, and have low impedances between different ones of the sources 108a, 108b, 109a-109d. If a high impedance (e.g., an impedance greater than a threshold impedance) is measured between two connected AC sources 108-112 by the AC power test circuitry 150, then the control circuitry 118 may determine or confirm that at least one of the connected sources 108-112 is an engine-driven generator 110 or battery-powered 120 VAC source 112. Similarly, 120 VAC mains line sources 108a, 108b and/or branches 109a-109d are in phase. The control circuitry 118 may determine or confirm that at least one of the connected sources 108-112 is an engine-driven generator 110 or battery-powered 120 VAC source 112 if a measured phase difference between two of the connected sources 108-112 is more than a threshold phase difference.

While multiple power sources 106-112 are connected to the multi-input welding-type power supply 102, the AC input monitor 138 and the DC input monitor 140 monitor for removal of any of the connected sources 106-112 (e.g., by repeatedly or regularly measuring an input voltage at the input connectors). If the AC input monitor 138 and/or the DC input monitor 140 detect removal of any of the connected sources 106-112, the control circuitry 118 controls a series relay or other switching element to disconnect (e.g., open-circuit) the connector from the corresponding preregulator 128a, 128b or DC-DC converter 130a, 130b.

In some examples, each input connection for connecting a power source may be connected to a user-controlled toggle switch, which controls electrical connection between the input connection and the corresponding preregulator 128a, 128b or DC-DC converter 130a, 130b.

As mentioned above, the load sharing circuitry 132 controls the input current draw from each of the connected sources 106-112. In some arrangements, one connected source of power (e.g., a mains source 108) may have significantly lower impedance than another source (e.g., a generator 110 or battery-powered 120 VAC source 112). To improve performance despite the dynamic nature of arc welding, the example load sharing circuitry 132 may control the preregulators 128a, 128b and/or the DC-DC converters 130a, 130b to supply more stable or consistent portions of the input power from a higher-impedance source 106-112 and to supply more dynamic portions of the input power from a lower-impedance source 106-112. A stable or consistent portion of the input power may include, for example, portions of the input power which are present throughout the weld and/or which have a ramp rate which is slower than a threshold ramp rate. Conversely, dynamic portions of the input power may include, for example, portions of the input power which vary by more than a threshold amount over the weld and/or which have a ramp rate which is faster than a threshold ramp rate.

In some examples, the load sharing circuitry 132 may respond to a step change in load (e.g., a change in load of at least a threshold amount in less than a threshold time) by determining the power factor correction states of each of the preregulators 128a, 128b, and controlling one of the preregulators 128a, 128b to adjust the current draw to respond to the step change in load based on the power factor correction. Controlling the preregulators 128a, 128b based on the power factor correction reduces the total current in the preregulators 128a, 128b and improves total system efficiency.

To adapt different types of batteries having different types of interfaces to the multi-input welding-type power supply 102, the batteries 106a, 106b may be supplied with or otherwise connected to respective battery adapters 152a, 152b, which electrically and physically interface with the batteries 106a, 106b to facilitate transfer of power from the batteries 106a, 106b to the DC-DC converters 130a, 130b. The battery adapter 152a accepts the physical battery connection of the battery 106a, and is further coupled to the multi-input welding-type power supply 102 to couple the battery A 106a to the DC-DC converter 130a. Similarly, the battery adapter 152b accepts the physical battery connection of the battery B 106b, and is further coupled to the multi-input welding-type power supply 102 to couple the battery 106b to the DC-DC converter 130b.

In some examples, the battery adapters 152a, 152b may include communications circuitry (similar to the battery communications circuitry 148a, 148b) to communicate properties of a connected battery to the communications circuitry 142. For example, for a battery adapter 152a which is configured to interface with one specific model of battery unit, the battery adapter 152a may communicate known properties of that model of battery. Additionally or alternatively, for a battery adapter 152a which is configured to interface with a set of battery units having one or more consistent properties, and/or for which one or more properties can be determined by the adapter (e.g., based on the adapter 152a determining which of multiple terminals are used by the connected battery, by the adapter 152a communicating with the battery communications circuitry 148a, 148b, etc.), the battery adapter 152a may communicate the determined properties of the connected battery 106a.

In some examples, the adapters 152a, 152b may be configured to be electrically and physically attached to multiple ones of the same type of battery. For example, the battery adapter 152a may have ports to accept two or more batteries simultaneously, such that the battery adapter 152a can connect the two or more batteries to the bidirectional DC-DC converter 130a, 130b simultaneously.

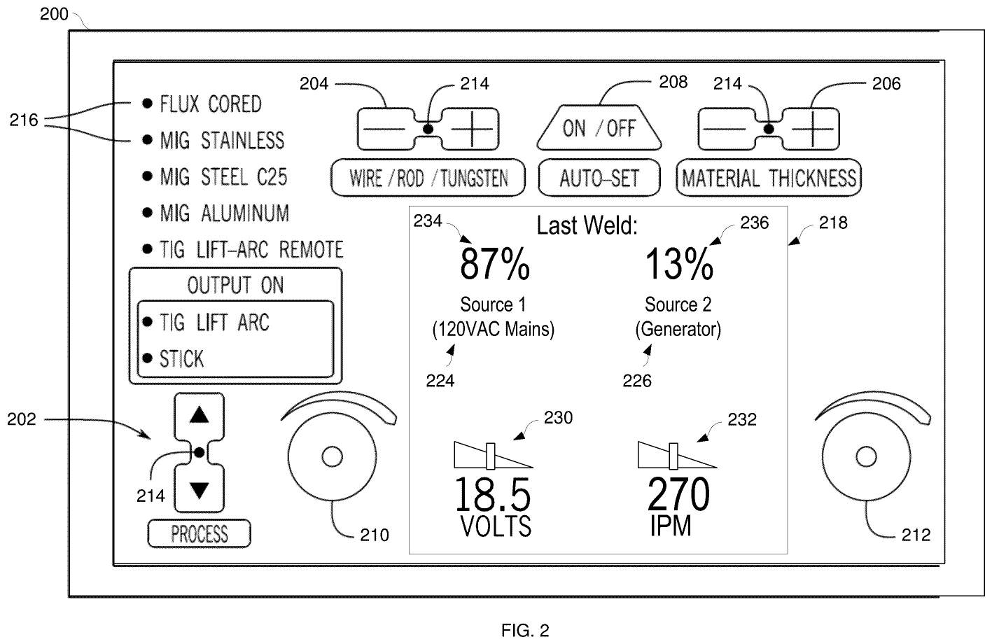

FIG. 2 illustrates an example user interface 200 which may implement the user interface 120 of FIG. 1 to display power drawn by the multi-input welding-type power supply 102 from each of multiple input power sources 106-112.

To enable an operator to specify welding parameters, the example user interface 200 includes a welding process selector 202, an electrode diameter adjustor 204, a material thickness adjustor 206, an Auto-Set selector 208, and welding parameter adjustment dials 210, 212.

The welding process selector 202 allows an operator or other user to select from a plurality of welding processes. For example, as depicted in FIG. 2, the welding process selector 202 may allow an operator to choose from welding processes, such as a stick welding process, a flux cored welding process, one or more metal inert gas (MIG) welding processes, one or more tungsten inert gas (TIG) welding processes, etc. In addition to general welding processes, in some examples, the welding process selector 202 may also allow the operator to select the material of the welding electrode. For example, the operator may further select a stainless steel, another type of steel, an aluminum electrode, and/or any other specific type of electrode for implementing the MIG process. In some examples, the welding process selector 202 may also allow an operator to select a desired combination of welding process (e.g., stick, MIG, TIG, etc.), electrode material type (e.g., steel, aluminum, etc.), and gas type (e.g., C25, C100, Argon, etc.), and subsequently elect to enable the Auto-Set function of the multi-input welding-type power supply 102 to automatically set the appropriate voltage and wire feed speed and/or amperage welding parameters. Example Auto-Set functionality is disclosed in greater detail in U.S. Pat. No. 8,604,389, which is herein incorporated by reference in its entirety.

The electrode diameter adjustor 204 allows selection of a diameter or size of a welding electrode, such as an electrode wire, an electrode rod, or tungsten electrode, depending on the type of welding process type selected. In the illustrated example, the electrode diameter adjustor 204 includes a “+” pushbutton to increase the electrode diameter setting and a “−” pushbutton to decrease the electrode diameter setting. The material thickness adjustor 206 allows selection of a material thickness of the workpiece. The material thickness adjustor 206 may include a “+” pushbutton to increase the material thickness setting and a “−” pushbutton to decrease the material thickness setting. The electrode diameter and material thickness settings, in conjunction, have an effect on the voltage and amperage (i.e., electrical current) required to perform a given welding procedure.

An operator or other user may select the Auto-Set function via the Auto-Set selector 208. When the Auto-Set feature is enabled (e.g., activated by the operator), the operator may only be required to input the respective electrode diameter and material thickness settings for the power conversion circuitry 116 to automatically adjust (e.g., increase or decrease) voltage, wire feed speed, amperage, and/or other parameters to appropriate settings. The Auto-Set selector 208 may be, for example, an on/off electrical switch or on/off pushbutton, which may be activated or deactivated, to allow the operator to enable or disable the Auto-Set function.

In the example of FIG. 2, the user interface 200 may include one or more light indicators 214 (e.g., LEDs in certain embodiments) to indicate whether the Auto-Set function is enabled or disabled. For example, in performing a MIG welding process, the operator may select the Auto-Set function, via the Auto-Set selector 208 and the one or more light indicators 214 may display a blue light, for example, or other indication to the operator that the Auto-Set function is enabled. Similarly, in some examples, the welding process selector 202 may be associated with a plurality of light indicators 216, each light indicator 216 being spatially aligned with a label corresponding to a respective welding process (e.g., “FLUX CORED”, “MIG STAINLESS”, and so forth). Manipulation of the welding process selector 202 changes the selected welding process, and the light indicator 216 that corresponds to the selected welding process displays, for example, a blue light, to indicate that the corresponding welding process has been selected.

The user interface 200 further includes a display screen 218 to output or convey information to the operator. The display screen 218 may be any display device capable of displaying visual graphical objects and/or alphanumeric texts relating to the setting of welding parameters, real-time operational statuses of the multi-input welding-type power supply 102, etc. For example, the display screen 218 may be a liquid crystal display (LCD) screen, an organic LED (OLED) display, and/or any other type of display capable of outputting information to the operator. The display screen 218 may display any or all of a selected electrode diameter (e.g., 0.030″), a selected material thickness (e.g., ⅛″), a selected power source welding voltage (e.g., 18.5 volts), and/or a selected wire feed speed (e.g., 270 inches per minute).

In some examples, any of the welding process selector 202, the electrode diameter adjustor 204, the material thickness adjustor 206, the Auto-Set selector 208, the welding parameter adjustment dials 210 and 212, may be displayed as graphical input devices on the display screen 218 (e.g., graphical buttons, graphical sliders, graphical knobs, etc.) instead of, or in addition to, physical input devices. For example, the display screen 218 may be a touchscreen configured to receive inputs from a user via such graphical input devices that are displayed on the display screen 218.

When the Auto-Set selector 208 is enabled, the display screen 218 may automatically display acceptable ranges of values of welding voltage and wire feed speed and/or amperage based upon inputs of the required electrode diameter and/or material thickness parameters (e.g., which are set based upon manipulation of the electrode diameter adjustor 204 and the material thickness adjustor 206). As used herein, an acceptable welding parameter value range may be a range of values within which the power conversion circuitry 116 holds the voltage and wire feed speed and/or amperage in response to an entered or estimated value of the electrode diameter and material thickness parameters, such that a weld may be effectively executed. For example, a welding operator may input an electrode diameter of 0.030″ and a material thickness of ⅛″ via the user interface 200. In response, the control circuitry 118 may automatically set appropriate welding parameter settings (e.g., 18.5 volts and 270 inches per minute) to effectively execute a weld for these particular electrode diameter and material thickness characteristics. The appropriate welding parameters may then be displayed via the display screen 218. The user interface 200 also includes welding parameter adjustment dials 210 and 212, which may be used to manually adjust (e.g., increase or decrease) the voltage and wire feed speed parameters and/or amperage parameter within acceptable ranges of values, depending on the particular type of welding process selected using the welding process selector 202.

Conversely, when the Auto-Set selector 208 is disabled, the operator may then manually adjust (e.g. increase or decrease) the welding voltage and wire feed speed parameters within an acceptable range of values (e.g., by manipulating the welding parameter adjustment dials 210 and 212, which correspond to the parameter displayed on the display screen 218 directly above respective welding parameter adjustment dial 210 and 212).

The example user interface 200 also provides guidance to the operator based on determined types and/or properties of the connected input power sources 106-112. In the example of FIG. 2, the display 218 includes power source indicators 224, 226, which provide information as to the identified input power sources 106-112. The power source indicators 224 may display information about detected batteries or other energy storage devices, such as the types of batteries (e.g., nominal voltages, brands, model numbers, etc.) and respective charge levels (e.g., remaining charge as a percentage of capacity, remaining ampere-hours, etc.), and/or information about connected AC power sources, such as the effective voltage of detected mains power sources 108 (e.g., 120 VAC for one connected mains power source 108a, 108b, 109a-d, 240 VAC for two connected mains power sources 108a, 108b, 109a-d).

In some examples, the control circuitry 118 may determine that some material thicknesses, welding processes, and/or other options are not supported based on the connected input power sources 106-112 (e.g., which may be derived from Auto-Set calculations or data). For example, if only a single input power source 106-112 is connected to the power inputs 114, a same branch 109a-109d of the mains power source 108 is connected to multiple input connections, and/or connected batteries 106a, 106b are determined to be depleted or have insufficient charge, the control circuitry 118 limits the values of the operational parameters that can be selected via the operator interface 200. For example, based on the determination, the control circuitry 118 may control the display 218 to hide material thicknesses that are unsupported, or depict certain material thickness settings that correspond to unsupported material thickness values using a different visual depiction than the indicators of a selected material thickness and different than other, supported material thicknesses. Similarly, the control circuitry 118 may control the display 218 to hide electrode diameters that are unsupported, or depict certain electrode diameter settings that correspond to unsupported electrode diameter values using a different visual depiction than the indicators of a selected electrode diameter and different than other, supported electrode diameters.

Additionally or alternatively, the example display 218 may include a voltage range indicator 230 and/or a wire feed speed range indicator 232. The example voltage range indicator 230 is depicted as a ramp with a positioning bar. The ramp may indicate to the operator the effect on welding duration, length, and/or other quantity as the voltage parameter increases (e.g., reduced duration, length, and/or other quantity) or decreases (e.g., increased duration, length, and/or other quantity). The control circuitry 118 determines the supported voltages to correspond to the voltage range indicator 230, and displays the positioning bar along the ramp to illustrate to the operator the value of the selected voltage with respect to the range. In the illustrated example, the upper limit of the voltage range depicted in the voltage range indicator 230 is determined based on the threshold welding duration, length, and/or other quantity.

Similarly, the example wire feed speed range indicator 232 is depicted as another ramp with a positioning bar. The wire feed speed ramp may indicate to the operator the effect on welding duration as the wire feed speed (which affects current output) increases (e.g., reduced duration) or decreases (e.g., increased duration). The control circuitry 118 determines the supported wire feed speeds to correspond to the wire feed speed range indicator 232, and displays the positioning bar along the ramp to illustrate to the operator the value of the selected wire feed speed with respect to the range. In the illustrated example, the upper limit of the wire feed speed range depicted in the wire feed speed range indicator 232 is determined based on the threshold welding duration.

While the example indicators 230, 232 are depicted as ramps, in other examples either or both of the indicators 230, 232 may be depicted as trapezoids or other shapes. For example, a trapezoidal indicator may define a central preferred range as a balance of welding speed to welding duration (e.g., welding can be done faster without sacrificing excessive welding duration), and outer ranges that indicate less preferred ranges. For example, voltage and/or wire feed speed ranges above the preferred range may allow welding of thicker materials and/or faster travel speeds, but have substantially shorter available welding durations. Conversely, voltage and/or wire feed speed ranges below the preferred range may provide longer available welding durations, but offer reduced available ranges of material thicknesses and/or have lower travel speeds.

In some examples, the welding parameter adjustment dials 210 and 212 may be configured to only accept values that fall within the supported ranges of values for the welding parameters. For example, when manual adjustments are attempted via the welding parameter adjustment dials 210 and 212 that would bring their respective parameters to values outside of their respective acceptable range of values depicted by the indicators 230, 232, such manual adjustments may simply be ignored by the control circuitry 118, and not indicated as having any effect on the parameters via the display screen 218. In some examples, the control circuitry 118 may display information indicating a reason for ignoring or limiting adjustments via the adjustment dials 210, 212, such as indicating that additional and/or different power sources are required (e.g., if connected input power sources are insufficient), that the connected batteries 106 should be charged (e.g., if the detected charge levels are less than 100% of capacity), and/or that additional battery capacity is required.

In some examples, the voltage range indicator 230 and/or the wire feed speed range indicator 232 may be displayed as an alternative to indicators associated with the Auto-Set function, which may display indicators based on suitability of welding according to the electrode diameter and material thickness parameters.

A user may want to see how power is being drawn from each connected input power source 106-112. The example display 218 further includes power consumption indicators 234, 236, which may be a number, graphic, and/or animation that displays the power drawn by the multi-input welding-type power supply 102 from each of multiple input power sources 106-112 during a welding-type operation. The power consumption indicators 234, 236 may display the power drawn in real time during a welding-type operation and/or as a summary or total at the conclusion of a welding-type operation. The power consumption indicators 234, 236 may display the power drawn in relative terms (e.g., as a percentage of total power drawn) and/or in units of power or energy, such as Ampere-hours (A-h), Joules, kilowatt-hours (kWh), and/or any other units. Additionally or alternatively, an LED or other visual or audible indicator may be provided on the interface 200 for each input source connection, which indicates the power or current drawn by adjusting intensities, colors, blink rates, and/or any other visual aspect, or volume, tone, pitch, and/or any other audible aspect.

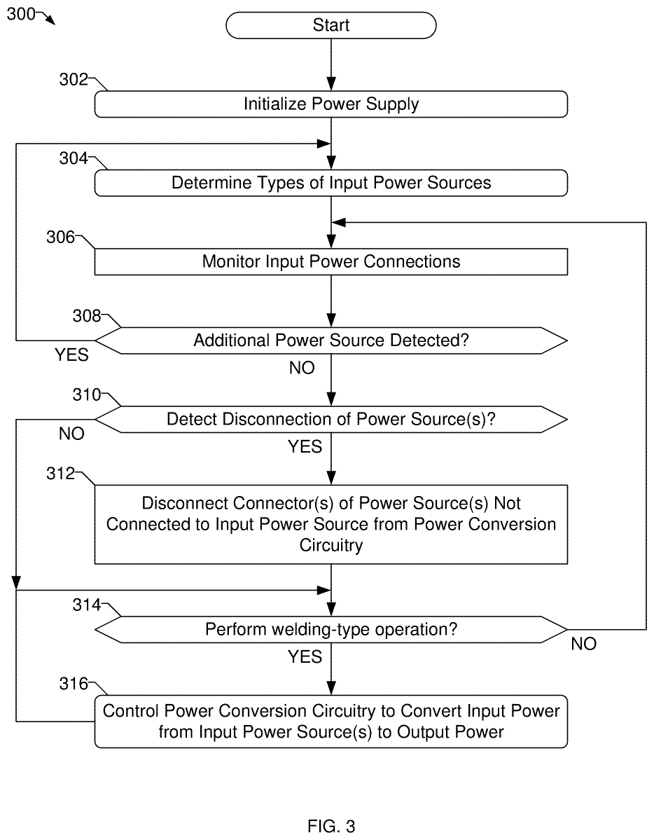

FIG. 3 is a flowchart representative of example machine-readable instructions 300 which may be executed by the multi-input welding-type power supply 102 of FIG. 1 to manage and use multiple input power sources for welding-type operations. The example instructions 300 may be stored in a computer readable memory or storage device (e.g., within the control circuitry 118 or coupled to the control circuitry 118) and executed by a processor or other processing circuitry within the control circuitry 118.

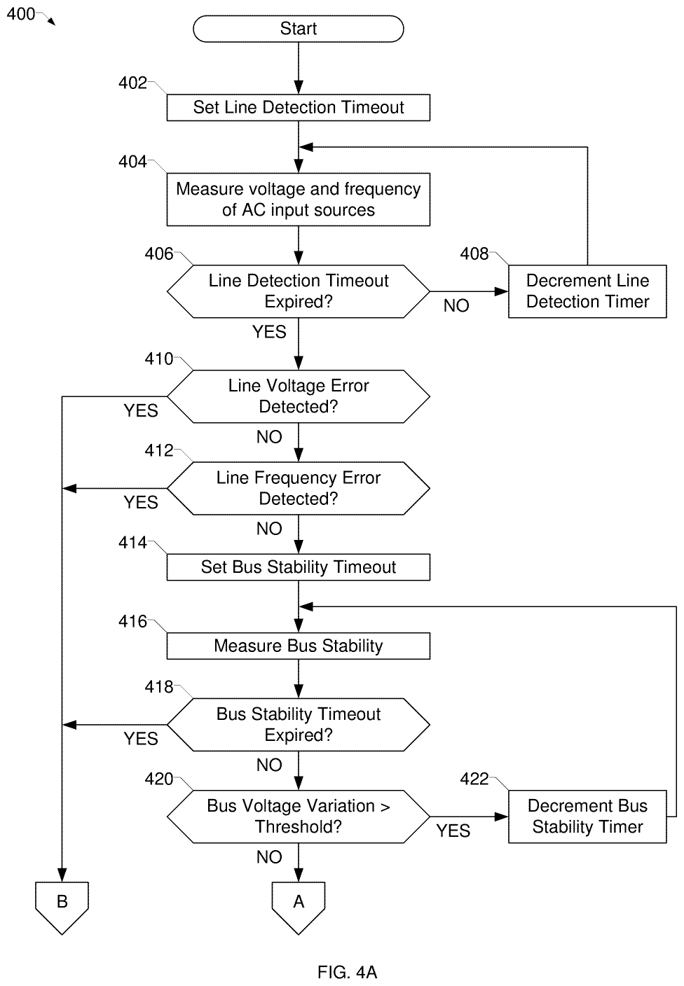

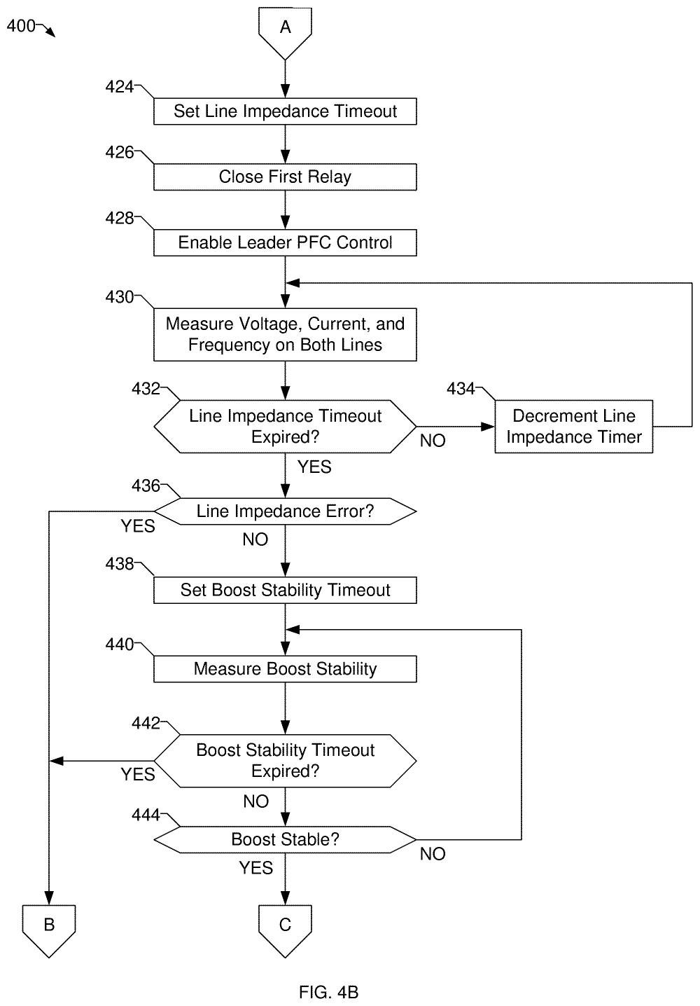

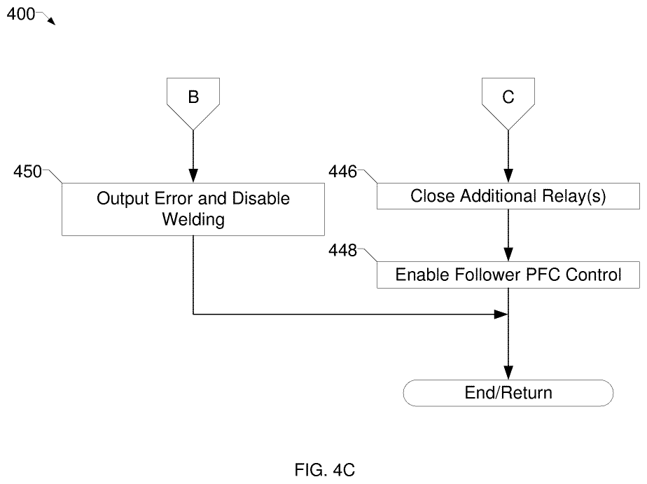

At block 302, the control circuitry 118 initializes the multi-input welding-type power supply 102. For example, the control circuitry 118 may detect which input power connections are connected to input power sources 106-112, charge a DC power bus 126, determine whether problematic conditions exist, and/or otherwise prepare the multi-input welding-type power supply 102 for welding. Example instructions to implement block 302 are described below with reference to FIGS. 4A-4C.

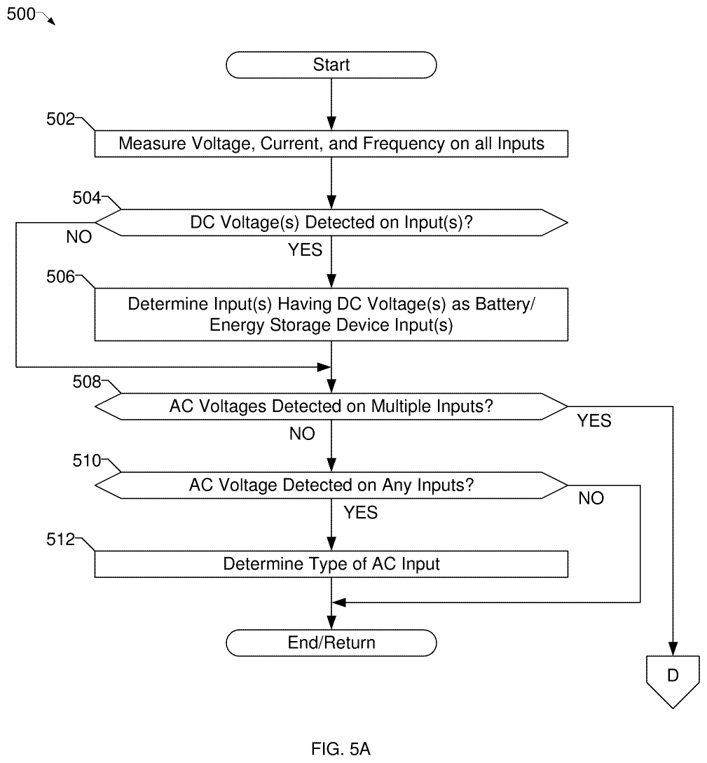

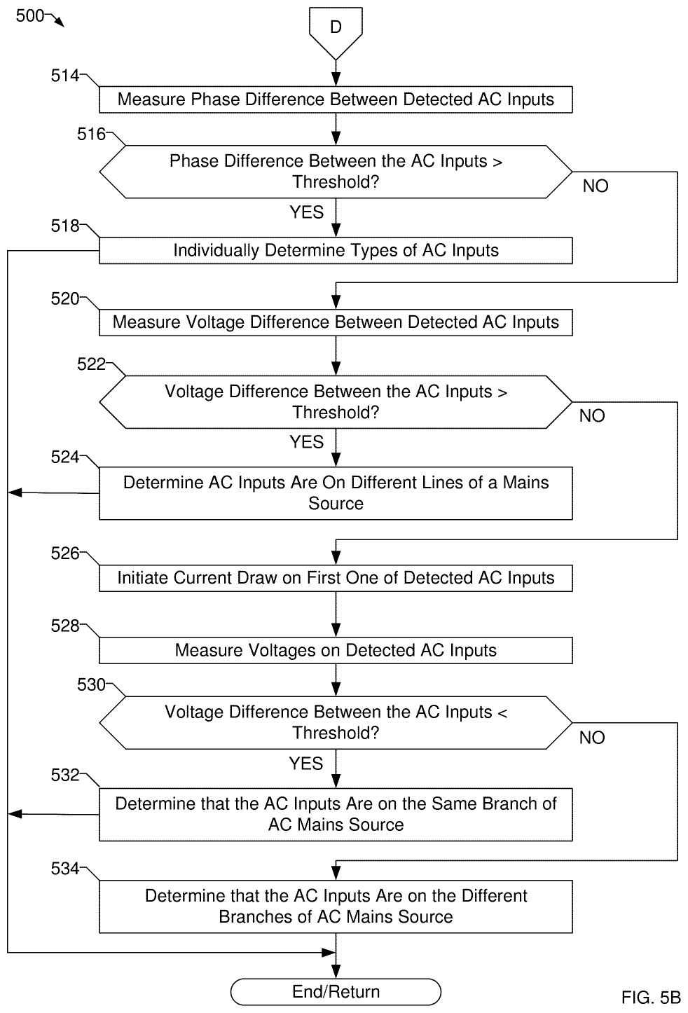

At block 304, the control circuitry 118 determines the types of connected input power sources 106-112. For example, the control circuitry 118 may use measurements obtained from the AC input monitor 138 and/or the DC input monitor 140 to automatically detect the types of connected power sources 106-112. Example instructions to implement block 304 are described below with reference to FIGS. 5A-5B.

At block 306, the control circuitry 118 monitors the input power connections. For example, the AC input monitor 138 and/or the DC input monitor 140 may measure the voltages, impedances, and/or other parameters at the input connectors to detect newly attached power sources and/or disconnections of previously attached power sources.

At block 308, the control circuitry 118 determines whether any additional power sources are detected (e.g., whether new power sources have been connected) based on the monitoring. If an additional power source is detected (block 308), control returns to block 304 to detect the type(s) of the attached power sources.

If no additional power sources are detected (block 308), at block 310 the control circuitry 118 determines whether disconnection(s) of power source(s) are detected. If a power source disconnection is detected (block 310), at block 312 the control circuitry 118 controls the power inputs 114 (e.g., a relay or other switching element) to disconnect the connector(s) of any power sources which are not connected to an input power source 106-112 from the power conversion circuitry 116. For example, the control circuitry 118 may control a relay for a disconnected connector to physically break the circuit to avoid transfer of power from another connected power source 106-112 to the exposed connector.

After disconnection (block 312), or if no disconnection was detected (block 310), at block 314 the control circuitry 118 determines whether a welding-type operation is to be performed. For example, the control circuitry 118 may determine whether an operator input (e.g., a trigger, a foot pedal, etc.) is received to initiate welding, and/or any other welding-type arc event is occurring. If a welding-type operation is not being performed (block 314), control returns to block 306 to continue monitoring the input power connections.

If a welding-type operation is being performed (block 314), at block 316 the control circuitry 118 controls the power conversion circuitry 116 to convert input power (e.g., from the connected input power sources 106-112 via the power inputs 114 and the DC bus 126) to output welding-type power (e.g., the welding-type output 124). Control then returns to block 314.

FIGS. 4A, 4B, and 4C illustrate a flowchart representative of example machine-readable instructions 400 which may be executed by the multi-input welding-type power supply 102 of FIG. 1 (e.g., via the control circuitry 118) to initialize the multi-input welding-type power supply 102. The example instructions 400 may implement block 302 of FIG. 3, and/or may be performed upon powering on of the multi-input welding-type power supply 102. While the example instructions 400 are described below with reference to up to two connected AC input power sources 108-112, in other examples the instructions 400 may be modified to perform the actions on more than two connected AC input power sources 108-112 (e.g., by performing portions of the instructions 400 with respect to pairs of input sources).

At block 402, the control circuitry 118 sets a line detection timeout. The line detection timeout may be a length of time sufficient for a representative set of measurements to be established to determine AC source voltages and frequencies. At block 404, the control circuitry 118 measures the voltages and frequencies of connected AC input power sources 108-112 (e.g., via the AC input monitor 138). At block 406, the control circuitry 118 determines whether the line detection timeout has expired and, if not, decrements a line detection timer at block 408 and returns control to block 404.

When the line detection timeout has expired (block 408), at block 410 the control circuitry 118 determines whether a line voltage error is detected or present. For example, the control circuitry 118 may use the measured voltages for each connected AC input power source 108-112 to determine whether a line voltage (e.g., an AC source voltage) is acceptable. For example, an acceptable line voltage may be a line voltage within a predetermined range, greater than a threshold voltage, less than a threshold voltage, and/or using any other criteria for acceptable line voltages.

If a line voltage error is not detected (block 410), at block 412 the control circuitry 118 determines whether a line frequency error is detected or present. For example, the control circuitry 118 may use the measured frequencies for each connected AC input power source 108-112 to determine whether a line frequency (e.g., an AC source frequency) is acceptable. For example, an acceptable line frequency may be a line frequency within a predetermined range, greater than a threshold frequency, less than a threshold frequency, and/or using any other criteria for acceptable line frequencies.

If a line frequency error is not detected (block 412), at block 414 the control circuitry 118 sets a bus stability timeout value. The bus stability timeout may be a threshold length of time within which the DC bus 126 is expected to stabilize (e.g., have less than a threshold variation over an arbitrary length of time) via the pre-charging circuitry 134a, 134b. At block 416, the control circuitry 118 measures a stability of the DC bus 126 (e.g., via a voltage sensor coupled to the DC bus 126). At block 418, the control circuitry 118 determines whether the bus stability timeout has expired and, if not, determines at block 420 whether the bus voltage variation is greater than a threshold. If the bus voltage variation is greater than the threshold (block 420), the control circuitry 118 decrements the bus stability timer at block 422 and returns to block 416 to continue monitoring the stability.

Turning to FIG. 4B, if the bus voltage variation is less than the threshold (block 420) prior to expiration of the bus stability timeout (block 418), at block 424 the control circuitry 118 sets a line impedance timeout. At block 426, the control circuitry 118 closes a relay (or other switching element) to connect a first one of multiple connected AC input power sources to a corresponding preregulator 128a. If the types of the connected AC input power sources 108-112 are previously determined, the example control circuitry 118 may select and close the relay of the leading power source.

At block 428, the control circuitry 118 enables power factor correction control for the preregulator 128a connected to the AC input power source. At block 430, the control circuitry 118 measures (e.g., via the AC input monitor 138) the voltages, currents, and frequencies on all lines (e.g., connected AC input power sources).

At block 432, the control circuitry 118 determines whether the line impedance timeout has expired and, if not, decrements the impedance timer at block 434 and returns control to block 430. When the line impedance timeout has expired (block 432), at block 436 the control circuitry 118 determines whether a line impedance error is detected or present. For example, a line impedance error may be detected when the impedances on two or more connected AC input power sources 108a, 108b, 109a-109d, 110, 112 are essentially the same such that the multi-input welding-type power supply 102 is connected to the same source via multiple connections. For example, if multiple outlets from the same 120 VAC mains branch 109a are plugged into separate connectors on the multi-input welding-type power supply 102, multiple outlets from the same engine-driven generator 110 are plugged into separate connectors on the multi-input welding-type power supply 102, and/or if multiple outlets from the same battery-powered VAC power source 112 are plugged into separate connectors on the multi-input welding-type power supply 102, the multi-input welding-type power supply 102 has multiple connections to the same source of power.

If there is no line impedance error detected (block 436), at block 438 the control circuitry 118 sets a boost stability timeout. At block 440, the control circuitry 118 measures a DC bus 126 stability while supplied by the boost circuitry 136a (e.g., at a higher bus voltage than supplied by the pre-charging circuitry 134a). The boost circuitry 136a converts power from the connected input power source 108-112 to intermediate power having an intermediate voltage to supply and maintain the DC bus 126 at the intermediate voltage.

At block 442, the control circuitry 118 determines whether the boost stability timeout has expired and, if not, determines at block 444 whether the DC bus 126 supplied by the boost circuitry 136a has a stable voltage (e.g., less than a threshold variation per unit time). If the DC bus 126 is not determined to be stable (block 444), control returns to block 440 to continue measuring the stability.

Turning to FIG. 4C, when the boost circuitry 136a has stabilized the voltage of the DC bus 126 before expiration of the bus stability timeout (block 444), at block 446 the control circuitry 118 controls additional relay(s) of connected power sources 106-112 to enable the power inputs 114 to draw power from the additional input power sources 106-112. At block 448, the control circuitry 118 enables power factor correction for the additional power source(s).

If the control circuitry 118 detects errors in any of the line voltage (block 410), the line frequency (block 412), the bus stability (block 418), the line impedance (block 436), and/or the boost stability (block 442), at block 450 the control circuitry 118 outputs an error indication and/or disables the power conversion circuitry 116 from performing welding-type operations. The example control circuitry 118 may output an error indication via the user interface 120, the communications circuitry 142, and/or any other method.

After determining the error (block 450), or after enabling the power inputs 114 after determining that no errors are present (block 448), the example instructions 400 end and control returns to block 304 of FIG. 3.

FIGS. 5A and 5B illustrate a flowchart representative of example machine-readable instructions 500 which may be executed by the multi-input welding-type power supply 102 of FIG. 1 to determine types of input power sources 106-112 connected to the multi-input welding-type power supply 102. The example instructions 500 may be performed by the control circuitry 118 to implement block 304 of FIG. 3.

At block 502, the control circuitry 118 measures voltage, current, and frequency on all connected input power sources 106-112. At block 504, the control circuitry 118 determines whether DC voltage(s) are detected on any of the connected inputs. For example, the DC input monitor 140 may determine whether any of the DC-DC converters 130a, 130b are connected to DC input voltages output by connected batteries 106. If DC voltage(s) are detected on the input(s) (block 504), at block 506 the control circuitry 118 determines that the input(s) having DC voltages are coupled to batteries 106 or other energy storage devices. Based on the identified connections of batteries, the example control circuitry 118 may use the batteries to supply input power for welding-type operations.

After determining which inputs are DC input (block 506), or if no DC voltages are detected (block 504), at block 508 the control circuitry 118 determines whether AC voltages are detected on multiple inputs (e.g., multiple connectors). For example, the AC input monitor 138 may determine whether AC voltages are present on multiple ones of the input connections.

If AC voltages are not detected on multiple inputs (block 508), at block 510 the control circuitry 118 determines whether an AC voltage is detected on at least one input. If an AC voltage is detected on one of the inputs (block 510), at block 512 the control circuitry 118 determines the type of the AC input. For example, the control circuitry 118 may determine a type of AC input power source based on any of observing a modified sine wave, observing variations in frequency with a varying load, observing line voltage regulation with varying load, measuring the source impedance, and/or any other techniques. The example instructions 500 may then end and return control to block 306 of FIG. 3.

Turning to FIG. 5B, if AC voltages are detected on multiple inputs (block 508), at block 514 the control circuitry 118 measures a phase difference between the detected AC input power sources (e.g., via the AC input monitor 138). At block 516, the control circuitry 118 determines whether the phase difference between the AC input sources is greater than a threshold. For example, while different lines and branches of a mains power source 108 are in phase, a mains power source 108 may not be in phase with a separate AC power source such as an engine-driven generator 110 or a battery-powered 120 VAC source 112.

If the phase difference between the AC inputs is greater than the threshold (block 516), at block 518 the control circuitry 118 individually determines the types of the connected AC input power sources 108-112. For example, the control circuitry 118 may determine the type of each the power source in a similar or identical manner as in block 512 of FIG. 5A. The example instructions 500 then end, and return control to block 306 of FIG. 3.

If the phase difference between the AC inputs is not greater than the threshold (block 516), at block 520 the control circuitry 118 measures a voltage difference between the detected AC input power sources 108-112 (e.g., via the AC input monitor 138). At block 522, the control circuitry 118 determines whether the voltage difference between the detected AC input power sources 108-112 is greater than a threshold voltage. For example, the different lines 108a, 108b of a 120 VAC power source 108 have an AC voltage difference of 230 VAC, while different branches 109a, 109b of the same line 108a and different 120 VAC sources 108-112 have a voltage difference between 0 VAC and 120 VAC. If the voltage difference is greater than the threshold (block 522), at block 524 the control circuitry 118 determines that the AC inputs are on different lines of a mains power source 108 and the example instructions 500 may end.

If the voltage difference is not greater than the threshold (block 522), at block 526 the control circuitry 118 controls one of the preregulators 128a, 128b to initiate a current draw on a corresponding one of the detected AC input power sources 108-112. The other of the preregulators 128b is controlled to not draw current, or the input power source may be disconnected from the preregulator 128b. At block 528, the control circuitry 118 measures the voltages on the detected AC input power sources 108-112.

At block 530, the control circuitry 118 determines whether a voltage difference between the connected AC input power sources 108-112 (e.g., measured at block 528 during the current draw of block 526) is less than a threshold. For example, if the measured AC input power sources are on the same branch 109a-109d or same power source of another type, any drop in voltage caused by a current draw would be observed on multiple input connectors by the AC input monitor 138, and the voltage difference would be small or negligible.

If the voltage difference is less than the threshold (block 530), at block 532 the control circuitry 118 determines that the measured AC input power sources are on the same branch 109a-109d of the AC mains power source 108. The example control circuitry 118 may respond by outputting an error indication via the user interface 120, disabling the power conversion circuitry 116 from performing welding-type operations, disconnecting one of the identical connections, or controlling the power conversion circuitry 116 using a single power source mode (e.g., power limited).

Conversely, if the voltage difference is not less than the threshold (block 530), at block 534 the control circuitry 118 determines that the measured AC input power sources are on different branches 109a, 109b of the same AC mains line 108a.

After determining whether the AC inputs are on the same branch (block 532) or different branches (block 534), the example instructions 500 may end and return control to block 306 of FIG. 3.

The present methods and systems may be realized in hardware, software, and/or a combination of hardware and software. Example implementations include an application specific integrated circuit and/or a programmable control circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A welding-type power supply, comprising:
two or more power converters configured to receive at least two different sources of input power, and to convert the at least two different sources of input power to welding-type power; and
control circuitry configured to:
determine a type of source of each of the sources of input power; and
control the two or more power converters based on the type of source.

2. The welding-type power supply as defined in claim 1, wherein the two or more power converters are configured to convert power from each of the at least two sources to intermediate power having a same intermediate voltage, and convert the intermediate power to a welding-type power.

3. The welding-type power supply as defined in claim 1, wherein the type of source of each of the sources of input power is selected from: a 120 VAC mains source; a branch of a multiple-branch 120 VAC mains source; a 120 VAC line of a split 240 VAC mains source; a battery-powered 120 VAC source; an engine-driven 120 VAC generator source; or a DC energy storage device.

4. The welding-type power supply as defined in claim 1, wherein the control circuitry is configured to, in response to determining that a first one of the sources is a 120 VAC mains source and a second one of the sources is a battery-powered 120 VAC source or an engine-driven 120 VAC generator source, control the two or more power converters to use the first one of the sources as a leading input power source and use the second one of the sources as a follower input power source.

5. The welding-type power supply as defined in claim 1, wherein the control circuitry is configured to, in response to determining that a first one of the sources is a first 120 VAC line of a split 240 VAC mains source and a second one of the sources is a second 120 VAC line of the 240 VAC mains source, control the two or more power converters to divide the input power between the first and second ones of the sources.

6. The welding-type power supply as defined in claim 1, wherein the control circuitry is configured to, in response to determining that a first one of the sources is a first branch of a 120 VAC mains source and a second one of the sources is a second branch of the 120 VAC mains source, control the two or more power converters to divide the input power between the first and second ones of the sources.

7. The welding-type power supply as defined in claim 1, wherein the control circuitry is configured to, in response to determining that a first one of the sources is a first branch of a 120 VAC mains source and a second one of the sources is the same first branch of the 120 VAC mains source, disable at least the second one of the two or more power converters to prevent drawing power from the same branch via multiple power converters.

8. The welding-type power supply as defined in claim 1, wherein the control circuitry is configured to, in response to determining that a first one of the sources is a first battery-powered 120 VAC source or engine-driven 120 VAC generator source and a second one of the sources is a second battery-powered 120 VAC source or engine-driven 120 VAC generator source, control the two or more power converters to divide the input power between the first and second ones of the sources.

9. The welding-type power supply as defined in claim 1, wherein the control circuitry is configured to, in response to determining that a first one of the sources is a first energy storage device and a second one of the sources is a second energy storage device, control the two or more power converters to divide the input power between the first and second ones of the sources.

10. The welding-type power supply as defined in claim 1, wherein the control circuitry is configured to, in response to determining that a first one of the sources is a 120 VAC mains source and a second one of the sources is an energy storage device, control the two or more power converters to use the first one of the sources as a leading input power source and use the second one of the sources as a following input power source.

11. The welding-type power supply as defined in claim 1, wherein the control circuitry is configured to, in response to determining that a first one of the sources is a battery-powered 120 VAC source or an engine-driven 120 VAC generator source and a second one of the sources is an energy storage device, control the two or more power converters to use the first one of the sources as a leading input power source and use the second one of the sources as a following input power source.

12. The welding-type power supply as defined in claim 1, wherein the control circuitry is configured to determine the type of source of the first input power based on at least one of: a characteristic of a voltage waveform or a current waveform of the first input power; a change in frequency in response to a change in load on the first input power; a magnitude of variation in voltage of the first input power in response to a change in load on the first input power; or a measured source impedance of the source of the first input power.

13. The welding-type power supply as defined in claim 1, wherein the control circuitry is configured to:
determine an impedance for each of the sources of input power; and
control the two or more power converters to draw power from the one of the sources that has a lower impedance to output dynamic portions of the welding-type power.

14. The welding-type power supply as defined in claim 1, wherein the two or more power converters comprise respective power factor correction circuits.

15. The welding-type power supply as defined in claim 14, wherein the control circuitry is configured to, in response to a step change in a load on the welding-type output power, control the two or more power converters to change the load drawn from one of the sources of input power based on the corresponding power factor of each of the power factor correction circuits.

16. The welding-type power supply as defined in claim 1, wherein the sources of input power have different input voltages.

17. The welding-type power supply as defined in claim 1, wherein the sources of input power have different input frequencies.

18. The welding-type power supply as defined in claim 1, wherein the sources of input power have different input phases.

19. The welding-type power supply as defined in claim 1, further comprising a user interface configured to display amounts of power drawn from each of the two or more input power sources.

20. The welding-type power supply as defined in claim 1, wherein the user interface is configured to display at least one of a percentage of total consumed power is drawn per source or a measured power drawn per source for a welding-type operation.

21. A welding-type power supply, comprising:
two or more power converters configured to receive at least two different sources of input power via corresponding input connectors, and to convert the at least two different sources of input power to welding-type power; and
control circuitry configured to:
control the two or more power converters to convert the sources of input power to welding-type power; and
in response to determining that one of the sources of input power is disconnected, controlling a switch to disconnect the disconnected one of the input connectors from other ones of the sources of input power.
